(19) United States
(12) Patent Application Publication
(10) Pub. No.: US 2013/0026072 A1
(43) Pub. Date: Jan. 31, 2013

(54) CATALYTIC COMPOSITIONS USEFUL IN REMOVAL OF SULFUR COMPOUNDS FROM GASEOUS HYDROCARBONS, PROCESSES FOR MAKING THESE AND USES THEREOF

(71) Applicants: Abdennour BOURANE, Ras Tanura (SA); Omer Refa Koseoglu, Dhahran (SA); Zinfer Ismagilov, Novosibirsk (RU); Svetlana Yashnik, Novosibirsk (RU); Mikhail Kerzhentsev, Novosibirsk (RU); Valentin Parmon, Novosibirsk (RU)

(72) Inventors: Abdennour BOURANE, Ras Tanura (SA); Omer Refa Koseoglu, Dhahran (SA); Zinfer Ismagilov, Novosibirsk (RU); Svetlana Yashnik, Novosibirsk (RU); Mikhail Kerzhentsev, Novosibirsk (RU); Valentin Parmon, Novosibirsk (RU)

(21) Appl. No.: 13/191,939

(22) Filed: Jul. 27, 2011

(51) Int. Cl. C10G 29/16; B01J 35/08; B01J 37/08; B01J 35/10; B01J 37/03; B01J 21/02; B01J 35/02

(52) U.S. Cl. 208/247; 502/342; 502/304

(57) ABSTRACT

A catalytic composition is disclosed, which exhibits an X-ray amorphous oxide, with a spinel formula and highly dispersed crystals of ZnO, CuO, and optionally CeO₂. The composition is useful in oxidative processes for removing sulfur from gaseous hydrocarbons.

### FIELD OF THE INVENTION

This invention relates to methods for removing sulfur-containing compounds from hydrocarbons. More particularly, it relates to such methods, using an oxidative process in the presence of a newly described catalyst, where the hydrocarbons are in gaseous phase. The catalytic compositions and processes for making these are also part of the invention.

### BACKGROUND AND PRIOR ART

The discharge into the atmosphere of sulfur compounds during processing and end-use of the petroleum products derived from sulfur-containing sour crude oil pose health and environmental problems. The stringent, reduced-sulfur specifications applicable to fuel products have impacted the refining industry, and made it necessary for refiners to take expensive and complex action so as to reduce the sulfur content in gas oils to 10 parts per million by weight (ppmw) or less. In industrialized nations such as the United States, Japan and the countries of the European Union, refineries for transportation fuel are already required to produce environmentally clean products. For instance, in 2007 the United States Environmental Protection Agency began requiring the sulfur content of highway diesel fuel to be reduced 97%, from 500 ppmw (low sulfur diesel) to 15 ppmw (ultra-low sulfur diesel). The European Union has enacted even more stringent standards, requiring diesel and gasoline fuels sold in 2009 and thereafter to contain less than 10 ppmw of sulfur. Other countries are following in the footsteps of the United States and the European Union and are moving forward with regulations that will require refineries to produce transportation fuels with ultra-low sulfur levels.

To keep pace with recent trends toward production of ultra-low sulfur fuels, refiners must now choose from processes and/or crude oils that provide flexibility so that future specifications relating to lower sulfur levels may be met with minimum additional capital investment, while using existing equipment. Conventional technologies such as hydrocracking and two-stage hydrotreating offer alternative solutions for production of clean transportation fuels. These technologies are available and can be applied as new grassroots production facilities are constructed; however, many existing hydroprocessing facilities, such as those using relatively low pressure hydrotreaters, represent substantial prior investments and were constructed before these more stringent sulfur reduction requirements were enacted. It is very difficult to upgrade existing hydrotreating reactors in these facilities because of the comparatively more severe operational requirements (e.g., higher temperature and pressure) needed to produce so-called “clean” fuel. Available retrofitting options for refiners include elevation of the hydrogen partial pressure by increasing the recycled gas quality, utilization of more active catalyst compositions, installation of improved reactor components to enhance liquid-solid contact, increase of reactor volume, and improvement of feedstock quality.

There are many hydrotreating units installed worldwide, which produce transportation fuels containing 500-3000 ppmw sulfur. These units were designed for, and are being operated at, relatively mild conditions (e.g., low hydrogen partial pressures of 30 kilograms per square centimeter for straight run gas oils with boiling points in the range of 180° C.-370° C.

The increasing prevalence of more stringent environmental sulfur specifications with the maximum allowable sulfur levels reduced to no greater than 15 ppmw, and in some cases no greater than 10 ppmw, present difficult challenges. This ultra-low level of sulfur in the end product typically requires either construction of new high pressure hydrotreating units, or a substantial retrofitting of existing facilities, e.g., by integrating new reactors, incorporating gas purification systems, reengineering internal configurations and components of reactors, and/or deployment of more active catalyst compositions.

Sulfur-containing compounds that are typically present in hydrocarbon fuels include aliphatic molecules such as sulfides, disulfides and mercaptans, as well as aromatic molecules such as thiophene, benzothiophene and its long chain alkylated derivatives, dibenzothiophene, and its alkyl derivatives such as 4,6-dimethyldibenzothiophene. Aromatic sulfur-containing molecules have a higher boiling point than aliphatic sulfur-containing molecules, and are consequently more abundant in higher boiling fractions.

In addition, certain fractions of gas oils possess different properties. The following table illustrates the properties of light and heavy gas oils derived from Arabian Light crude oil:

TABLE 1

| Feedstock Name | | Light | Heavy |
|---|---|---|---|
| Blending Ratio | | — | — |
| API Gravity | ° | 37.5 | 30.5 |
| Carbon | W % | 85.99 | 85.89 |
| Hydrogen | W % | 13.07 | 12.62 |
| Sulfur | W % | 0.95 | 1.65 |
| Nitrogen | ppmw | 42 | 225 |
| ASTM D86 Distillation | | | |
| IBP/5 V % | ° C. | 189/228 | 147/244 |
| 10/30 V % | ° C. | 232/258 | 276/321 |
| 50/70 V % | ° C. | 276/296 | 349/373 |
| 85/90V % | ° C. | 319/330 | 392/398 |
| 95 V % | ° C. | 347 | |
| Sulfur Speciation | | | |
| Sulfur Compounds Boiling | ppmw | 4591 | 3923 |
| Less than 310° C. | | | |
| Dibenzothiophenes | ppmw | 1041 | 2256 |
| C₁-Dibenzothiophenes | ppmw | 1441 | 2239 |
| C₂-Dibenzothiophenes | ppmw | 1325 | 2712 |
| C₃-Dibenzothiophenes | ppmw | 1104 | 5370 |

As set forth above in Table 1, the light and heavy gas oil fractions have ASTM D85 95 V % points of 319° C. and 392° C., respectively. Further, the light gas oil fraction contains less sulfur and nitrogen than the heavy gas oil fraction (0.95 W % sulfur as compared to 1.65 W % sulfur and 42 ppmw nitrogen as compared to 225 ppmw nitrogen).

Advanced analytical techniques such as multi-dimensional gas chromatography (Hua R., et al., Journal of Chromatog. A, 1019 (2003) 101-109), have shown that the middle distillate cut boiling in the range of 170-400° C. contains sulfur species including thiols, sulfides, disulfides, thiophenes, benzothiophenes, dibenzothiophenes, and benzonaphthothiophenes, with and without alkyl substituents.

The sulfur specification and content of light and heavy gas oils are conventionally analyzed by two methods. In the first method, sulfur species are categorized based on structural groups. The structural groups include one group having sulfur-containing compounds boiling at less than 310° C., including dibenzothiophenes and their alkylated isomers, and another group including I-, 2- and 3-methyl-substituted dibenzothiophenes, denoted as C₁, C₂ and C₃, respectively. Based on this method, the heavy gas oil fraction contains more alkylated di-benzothiophene molecules than the light gas oils.

In the second method of analysis, the sulfur content of light and heavy gas oils are plotted against the boiling points of the sulfur-containing compounds to observe concentration variations and trends. See, e.g., FIG. 1 of Koseoglu, et al., Saudi Aramco Journal of Technology, 66-79 (Summer 2008), incorporated by reference. Note that the boiling points depicted are those of sulfur-containing compounds that were detected rather than the boiling point of the total hydrocarbon mixture. The boiling point of the key sulfur-containing compounds consisting of dibenzothiophenes, 4-methydibenzothiophenes and 4,6-dimethyldibenzothiophenes are also shown in FIG. 1. The cumulative sulfur specification curves show that the heavy gas oil fraction contains a higher content of heavier sulfur-containing compounds and lower content of lighter sulfur-containing compounds as compared to the light gas oil fraction. For example, it is found that 5370 ppmw of C₃-dibenzothiophene, and bulkier molecules such as benzonaphthothiophenes, are present in the heavy gas oil fraction, compared to 1104 ppmw in the light gas oil fraction. In contrast, the light gas oil fraction contains a higher content of light sulfur-containing compounds compared to heavy gas oil. Light sulfur-containing compounds are structurally less bulky than dibenzothiophenes and boil at less than 310° C. Also, twice as much C₁ and C₂ alkyl-substituted dibenzothiophenes exist in the heavy gas oil fraction as compared to the light gas oil fraction.

Aliphatic sulfur-containing compounds are more easily desulfurized (labile) using conventional hydrodesulfurization methods. However, certain highly branched aliphatic molecules can hinder the sulfur atom removal and are moderately more difficult to desulfurize (refractory) using conventional hydrodesulfurization methods.

Among the sulfur-containing aromatic compounds, thiophenes and benzothiophenes are relatively easy to hydrodesulfurize. The addition of alkyl groups to the ring compounds increases the difficulty of hydrodesulfurization. Dibenzothiophenes resulting from addition of another ring to the benzothiophene family are even more difficult to desulfurize, and the difficulty varies greatly according to their alkyl substitution, with di-beta substituted compounds being the most difficult to desulfurize, thus justifying their “refractory” appellation. These beta substituents hinder exposure of the heteroatom to the active site on the catalyst.

The economical removal of refractory sulfur-containing compounds is therefore exceedingly difficult to achieve, and accordingly removal of sulfur-containing compounds in hydrocarbon fuels to an ultra-low sulfur level using current hydrotreating techniques is very costly. When previous regulations permitted sulfur levels up to 500 ppmw, there was little need or incentive to desulfurize beyond the capabilities of conventional hydrodesulfurization processes and hence the refractory sulfur-containing compounds were not targeted; however, in order to meet the more stringent sulfur specifications, these refractory sulfur-containing compounds must be substantially removed from hydrocarbon fuels streams.

Relative reactivities of sulfur-containing compounds based on their first order reaction rates at 250° C. and 300° C. and 40.7 Kg/cm² hydrogen partial pressure over Ni—Mo alumina catalyst, and activation energies, are given in Table 2 (Steher et al., Fuel Processing Technology, 79:1-12 (2002)):

TABLE 2

| | | | 4,6-dimethy-dibenzo- |
|---|---|---|---|
| Name | Dibenzothiophene | 4-methy-dibenzo-thiophene | thiophene |
| Temperature | 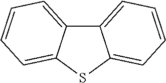 [SMILES: c1ccc2c(c1)sc1ccccc12] | 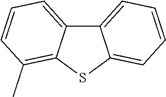 | 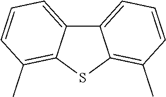 |
| k_{@250}, s⁻¹ | 57.7 | 10.4 | 1.0 |
| k_{@300}, s⁻¹ | 7.3 | 2.5 | 1.0 |
| Ea, Kcal/mol | 28.7 | 36.1 | 53.0 |

As is apparent from Table 2, dibenzothiophene is 57 times more reactive than the refractory 4,6-dimethyldibenzothiphene at 250° C. The relative reactivity decreases with increasing operating severity. With a 50° C. temperature increase, the relative reactivity of di-benzothiophene compared to 4,6-dibenzothiophene decreases to 7.3 from 57.7.

The development of non-catalytic processes for desulfurization of petroleum distillate feedstocks has been widely studied, and certain conventional approaches are based on oxidation of sulfur-containing compounds are described, e.g., in U.S. Pat. Nos. 5,910,440, 5,824,207, 5,753,102, 3,341,448 and 2,749,284.

Oxidative desulfurization as applied to middle distillates is attractive for several reasons. First, mild reaction conditions, e.g., temperatures ranging from room temperature up to 200° C. and pressures ranging from 1 up to 15 atmospheres, are normally used, thereby resulting a priori in reasonable investment and operational costs, especially for hydrogen consumption, which is usually expensive. Another attractive aspect is related to the reactivity of high aromatic sulfur-containing species. This is evident since the high electron density at the sulfur atom caused by the attached, electron-rich aromatic rings, further increased by the presence of additional alkyl groups on the aromatic rings, will favor its electrophilic attack as shown in Table 3 (Otsuki, et al., Energy Fuels, 14:1232 (2000)). However, the intrinsic reactivity of molecules such as 4,6-DMBT should be substantially higher than that of DBT, which is much easier to desulfurize by hydrodesulfurization.

TABLE 3
Electron density of selected sulfur species

| | | | K |
|---|---|---|---|
| Sulfur compound | Formulas | Electron Density | (L/(mol•min)) |
| Thiophenol | 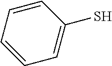 | 5.902 | 0.270 |
| Methyl Phenyl Sulfide | 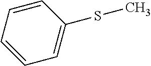 | 5.915 | 0.295 |
| Diphenyl Sulfide | 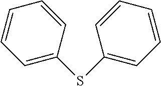 [SMILES: c1ccc(Sc2ccccc2)cc1] | 5.860 | 0.156 |
| 4,6-DMDBT | 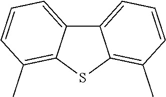 | 5.760 | 0.0767 |
| 4-MDBT | 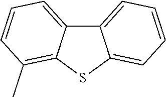 | 5.759 | 0.0627 |
| Dibenzothiophene | 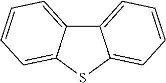 [SMILES: c1ccc2c(c1)sc1ccccc12] | 5.758 | 0.0460 |
| Benzothiophene | 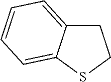 | 5.739 | 0.00574 |
| 2,5-Dimethylthiophene | 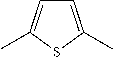 | 5.716 | — |
| 2-methylthiophene | 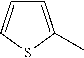 | 5.706 | — |
| Thiophene | 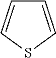 | 5.696 | — |

Certain existing desulfurization processes incorporate both hydrodesulfurization and oxidative desulfurization. For instance, Cabrera et al., U.S. Pat. No. 6,171,478 describes an integrated process in which the hydrocarbon feedstock is first contacted with a hydrodesulfurization catalyst in a hydrodesulfurization reaction zone to reduce the content of certain sulfur-containing molecules. The resulting hydrocarbon stream is then sent in its entirety to an oxidation zone containing an oxidizing agent where residual sulfur-containing compounds are converted into oxidized sulfur-containing compounds. After decomposing the residual oxidizing agent, the oxidized sulfur-containing compounds are solvent extracted, resulting in a stream of oxidized sulfur-containing compounds and a reduced-sulfur hydrocarbon oil stream. A final step of adsorption is carried out on the latter stream to further reduce the sulfur level.

Kocal, U.S. Pat. No. 6,277,271 also discloses a desulfurization process integrating hydrodesulfurization and oxidative desulfurization. A stream composed of sulfur containing hydrocarbons and a recycle stream containing oxidized sulfur-containing compounds is introduced in a hydrodesulfurization reaction zone and contacted with a hydrodesulfurization catalyst. The resulting hydrocarbon stream containing a reduced sulfur level is contacted in its entirety with an oxidizing agent in an oxidation reaction zone to convert the residual sulfur-containing compounds into oxidized sulfur-containing compounds. The oxidized sulfur-containing compounds are removed in one stream and a second stream of hydrocarbons having a reduced concentration of oxidized sulfur containing compounds is recovered. Like the process in Cabrera et al., the entire hydrodesulfurized effluent is subjected to oxidation in the Kocal process.

Wittenbrink et al., U.S. Pat. No. 6,087,544 discloses a desulfurization process in which a distillate feedstream is first fractionated into a light fraction containing from about 50 to 100 ppm of sulfur, and a heavy fraction. The light fraction is passed to a hydrodesulfurization reaction zone. Part of the desulfurized light fraction is then blended with half of the heavy fraction to produce a low sulfur distillate fuel. However, not all of the distillate feedstream is recovered to obtain the low sulfur distillate fuel product, resulting in a substantial loss of high quality product yield.

Rappas et al., PCT Publication No. WO 02118518 discloses a two-stage desulfurization process located downstream of a hydrotreater. After having been hydrotreated in a hydrodesulfurization reaction zone, the entire distillate feedstream is introduced to an oxidation reaction zone to undergo biphasic oxidation in an aqueous solution of formic acid and hydrogen peroxide. Thiophenic sulfur-containing compounds are converted to corresponding sulfones. Some of the sulfones are retained in the aqueous solution during the oxidation reaction, and must be removed by a subsequent phase separation step. The oil phase containing the remaining sulfones is subjected to a liquid-liquid extraction step. In the process of WO 02118518, like Cabrera et al. and Kocal, the entire hydrodesulfurized effluent is subject to oxidation reactions, in this case biphasic oxidation.

Levy et al., PCT Publication No. WO 031014266 discloses a desulfurization process in which a hydrocarbon stream having sulfur-containing compounds is first introduced to an oxidation reaction zone. Sulfur-containing compounds are oxidized into the corresponding sulfones using an aqueous oxidizing agent. After separating the aqueous oxidizing agent from the hydrocarbon phase, the resulting hydrocarbon stream is passed to a hydrodesulfurization step. In the process of WO 031014266, the entire effluent of the oxidation reaction zone is subject to hydrodesulfurization.

Gong et al., U.S. Pat. No. 6,827,845 discloses a three-step process for removal of sulfur- and nitrogen-containing compounds in a hydrocarbon feedstock. All or a portion of the feedstock is a product of a hydrotreating process. In the first step, the feed is introduced to an oxidation reaction zone containing peracid that is free of catalytically active metals. Next, the oxidized hydrocarbons are separated from the acetic acid phase containing oxidized sulfur and nitrogen compounds. In this reference, a portion of the stream is subject to oxidation. The highest cut point identified is 316° C. In addition, this reference explicitly avoids catalytically active metals in the oxidation zone, which necessitates an increased quantity of peracid and more severe operating conditions. For instance, the H₂O₂:S molar ratio in one of the examples is 640, which is extremely high as compared to oxidative desulfurization with a catalytic system.

Gong et al., U.S. Pat. No. 7,252,756 discloses a process for reducing the amount of sulfur- and/or nitrogen-containing compounds for refinery blending of transportation fuels. A hydrocarbon feedstock is contacted with an immiscible phase containing hydrogen peroxide and acetic acid in an oxidation zone. After a gravity phase separation, the oxidized impurities are extracted with aqueous acetic acid. A hydrocarbon stream having reduced impurities is recovered, and the acetic acid phase effluents from the oxidation and the extraction zones are passed to a common separation zone for recovery of the acetic acid. In an optional embodiment, the feedstock to the oxidation process can be a low-boiling component of a hydrotreated distillate. This reference contemplates subjecting the low boiling fraction to the oxidation zone.

M. A. Ledile, et al., Tetrahedron Lett., 10:785 (1976) reported the use of RuOx for oxidation of DBT at 100° C. under 70 bar of air. Sulfur conversion of 97% was obtained after 12 hours.

Recently, the use of cobalt and manganese based catalysts in air based oxidation of DBT type aromatic sulfur compounds into polar sulfones and/or sulfoxides has been described. A wide number of transition metal oxides, including MnO₂, Cr₂O₃, V₂O₅, NiO, MoO₃ and Co₃O₄, or as well transition metal containing compounds such as chromates, vanadates, manganates, rhenates, molybdates and niobates are described, but the more active and selective compounds were manganese and cobalt oxides. It was shown that the manganese or cobalt oxides containing catalysts provided 80% oxidation conversion of DBT at 120° C. One advantage these catalysts is that the treatment of fuel takes place in the liquid phase. The general reaction scheme for the ODS process suggested is as follows: sulfur compound R—S—R′ is oxidized to sulfone R—SO₂—R′, and the latter can decompose with heating, to liberate SO₂ and R—R′, while leaving behind a useful hydrocarbon compounds that can be utilized. A recommended temperature is from 90° C. to 250° C. See, PCT Application No. WO 2005/116169.

High catalytic activity of manganese and cobalt oxides supported on Al₂O₃ in oxidation of sulfur compounds at 130-200° C. and atmospheric pressure has been described by Sampanthar J. T., et al., Appl. Catal. B: Environm., 63(1-2):85-93 (2006). The authors show that, after the subsequent extraction of the oxidation products with a polar solvent, the sulfur content in the fuel decreased to 40-60 ppmw. The thiophenes conversion increased with time and it reached its maximum conversion of 80-90% in 8 h. It was shown that the trisubstituted dibenzothiophene compounds were easier to be oxidized than the monosubstituted dibenzothiophenes. The oxidative reactivity of S-compounds in diesel follows the order: trialkylsubstituted dibenzothiophene>dialkyl-substituted dibenzothiophene>monoalkyl-substituted dibenzothiophene>dibenzothiophene. These results showed that the most refractory sulfur compounds in the diesel hydrodesulfurization were more reactive in the oxidative desulfurization of fuel.

U.S. Pat. No. 5,969,191 describes a catalytic thermochemical process. A key catalytic reaction step in the thermochemical process scheme is the selective catalytic oxidation of organosulfur compounds (e.g., mercaptan) to a valuable chemical intermediate (e.g., CH₃SH+2O₂->H₂CO+SO₂+H₂O) over certain supported (mono-layered) metal oxide catalysts. The preferred catalyst employed in this process consists of a specially engineered V₂O₅/TiO₂ catalyst that minimizes the adverse effects of heat and mass transfer limitations that can result in the over oxidation of the desired H₂CO to COₓ and H₂O.

The process described later by the inventors in PCT Application No. WO 2003/051798 (A1) involves contacting of heterocyclic sulfur compounds in a hydrocarbon stream, e.g., in a petroleum feedstock or petroleum product, in the gas phase in the presence of oxygen with a supported metal oxide catalyst, or with a bulk metal oxide catalyst to convert at least a portion of the heterocyclic sulfur compounds to sulfur dioxide and to useful oxygenated products as well as sulfur-deficient hydrocarbons and separately recovering the oxygenated products separately from a hydrocarbon stream with substantially reduced sulfur. The catalytic metal oxide layer supported by the metal oxide support is based on a metal selected from the group consisting of Ti, Zr, Mo, Re, V, Cr, W, Mn, Nb, Ta, and mixtures thereof. Generally, a support of titania, zirconia, ceria, niobia, tin oxide or a mixture of two or more of these is preferred. Bulk metal oxide catalysts based on molybdenum, chromium and vanadium can be also used. Sulfur content in fuel could be less than about 30-100 ppmw. The optimum space velocity likely will be maintained below 4800 V/V/hr and temperature will be 50-200° C.

The vapor-phase oxidative desulfurization of various sulfur compounds (such as: COS, or CS₂, CH₃SH, CH₃SCH₃, CH₃SSCH₃, thiophene and 2,5-dimethylthiophene) by use of sulfur-tolerant V₂O₅-containing catalysts on different supports has been taught by Choi, S.; et al., Preprints of Symposia—American Chemical Society, Division of Fuel Chemistry, 47(1):138-139 (2002) 138-139 and Choi S., et al., Preprints of Symposia—American Chemical Society, Division of Fuel Chemistry, 49(2):514-515 (2004). In these papers, the feed gas contained 1000 ppmw of COS, or CS2, CH₃SH, CH₃SCH₃, CH₃SSCH₃, thiophene and 2,5-dimethylthiophene, 18% O₂ in He balance. The formed products (formalin, CO, H2, maleic anhydride and SO2) were monitored by temperature programmed surface reaction mass spectrometry. It was shown that the turnover frequency for COS and CS₂ oxidation varied by about one order of magnitude depending on the support, in the order CeO₂>ZrO₂>TiO₂>Nb₂O₅>Al₂O₃—SiO₂.

A common catalyst for oxidative desulfurization is activated carbon (Yu et al., Energy & Fuels, 19(2):447-452 (2005), Wu et al., Energy and Fuels, 19(5):1774-1782 (2005)). The application of this method allows removal of hydrogen sulfide from gaseous fuels at 150° C. by oxidation with air (Wu et al., Energy and Fuels, 19(5):1774-1782 (2005) and also sulfur removal from diesel fuels using hydrogen peroxide (Yu et al., Energy & Fuels, 19(2):447-452 (2005)). The higher adsorption capacity of the carbon, the higher its activity in the oxidation of dibenzothiophene.

The prior art evidences different ways to approach the problem of desulfurizing fuels.

U.S. Pat. No. 7,749,376 to Turbeville, et al., describes catalytic processes whereby sulfur-containing compounds are adsorbed onto a catalytic bed. The process is carried out with liquid hydrocarbons, at low temperatures. It is a non-oxidative process, which uses a catalyst with a hydrotalcite structure of the form (Cu,Zn)₆Al₂(OH)₁₆CO₃4H₂O₂.

U.S. Pat. No. 4,596,782 to Courty, et al., teaches a catalytic process for producing ethanol and methanol. The catalyst requires activation via, e.g., reducing conditions and a substance such as H₂, CO, or an alcohol.

U.S. Pat. No. 3,945,914 to Yoo, et al., describes a catalytic process for removing sulfur compounds from liquid hydrocarbons. The catalyst employed differs markedly from the invention described herein.

U.S. Pat. No. 2,640,010 to Hoover, et al., describes a process for removing sulfur-containing compounds from gaseous phase hydrocarbons; however, the catalyst is markedly different from the present invention.

None of these references teach or suggest the catalytic composition of the invention, its use in removal of sulfur containing compounds from gaseous phase hydrocarbons in an oxidative process, or the processes by which these catalysts are made.

Therefore, a need exists for an efficient and effective process and apparatus for desulfurization of hydrocarbon fuels to an ultra-low sulfur level.

Accordingly, it is an object of the present invention to desulfurize a hydrocarbon fuel stream containing different classes of sulfur-containing compounds having different reactivities, utilizing reactions separately directed to labile and refractory classes of sulfur-containing compounds.

It is a further object of the present invention to produce hydrocarbon fuels having an ultra-low sulfur level by gas phase oxidative desulfurization of refractory organosulfur compounds.

As used herein in relation to the apparatus and process of the present invention, the term “labile organosulfur compounds” means organosulfur compounds that can be easily desulfurized under relatively mild hydrodesulfurization pressure and temperature conditions, and the term refractory organosulfur compounds” means organosulfur compounds that are relatively more difficult to desulfurize under mild hydrodesulfurization conditions.

How the various aspects of the invention are achieved will be seen in the detailed description which follows.

### DETAILED DESCRIPTION OF PREFERRED EMBODIMENTS

### Example 1

CuNO₃, (0.2 moles), ZnNO₃ (0.07 moles), and Al₂NO₃ (0.235 moles), were dissolved in 500 ml of distilled water, to form what shall be referred to as “solution A” hereafter. The pH of the solution was 2.3.

Similarly, 19.08 g of Na₂CO₃, (0.18 moles), and 36 g of NaOH (0.9 moles), were dissolved in 600 ml of distilled water, to produce “solution B,” which had a pH of 12.0.

Solution A was heated to 65° C. and solution B was added to solution A, at a rate of about 5 ml/minute, with constant agitation, until all of solution B was added. The resulting mixture had a pH of 11.0. A precipitate resulted which was aged, for 6 hours, at 65° C., pH 11. The solution was cooled to room temperature and filtered with a Buchner funnel. Precipitate was washed with distilled water. Analysis showed that nearly all of the Cu, Zn, and Al precipitated out of the solution (99%).

The precipitate was then dried at room temperature, for 12 hours, at 110° C. The dried material was dark brown in color. Following drying, it was calcined, at 500° C., for 2 hours.

The calcined product contained 36 wt % elemental Cu, 12.1 wt % elemental Zn, 14.2 wt % elemental Al, and 0.82 wt % elemental Na. (In all of the examples which follow, weight percent is given in terms of the pure element, rather than the oxide.) In order to determine the weight percent of the oxide in the composition, one divides the amount of element by its molecular weight, multiplies by the molecular weight of the oxide, and then normalizes to 100%. As an example, for the composition described herein, the wt % of Cu (36), is divided by the molecular weight of Cu, which is 63.54 to yield 0.567. This is multiplied by the molecular weight of CuO, which is 79.54 to yield 45.07. When similar operations are performed on the Zn and Al amounts, values of 15.56 and 53.66, respectively, are obtained, which normalize to 39.43 wt % CuO, 13.61% ZnO, and 46.95 wt % Al₂O₃.

The atomic ratio of Cu:Zn:Al was 3:1:2.8. The product had a specific surface area of 94 m²/g, pore volume of 0.24 cm³/g, and an average pore diameter of 9.5 nm. It exhibited highly dispersed CuO and ZnO, with an X-ray amorphous oxide phase. “X-ray amorphous oxide phase” as used herein means that, when observed via high resolution transmission electron microscopy (“HRTEM”), crystalline particles ranging from 2-10 μm, and usually 2-5 nm, were observed. Lattice parameters were very close to those of spinets, hence the formula, Cu_{0.3}Zn_{0.7}Al₂O₄.

### Example 2

A 500 ml sample of solution A was prepared as was 600 ml of a new solution B, which contained 1 mole of (NH₄)₂CO₃, at pH 8.7.

Solution A was heated to 65° C., and solution B was added gradually to solution A, with constant agitation. The combined solution had a pH of 7.6.

Following combination of solutions A and B, a precipitate formed, which was aged for 1 hour at 65° C. The precipitate was filtered in the same way the precipitate of Example 1 was filtered, and was then washed with room temperature distilled water. Analysis showed the precipitate contained about 99% of the Zn and Al, and 80-85% of the Cu.

Precipitate was dried, as in Example 1, supra, and then calcined at 500° C. for 4 hours.

The resulting compound was 26.3 wt % Cu, 15.8 wt % Zn, 22.3 wt % Al, and the atomic ratio of Cu:Zn:Al was 1.7:1:3.5. The compound had a specific surface area of 82 m²/g, pore volume of 0.29 cm³/g, and an average pore diameter of 12 nm. It exhibited an X-ray amorphous oxide phase (Cu_{0.45}Zn_{0.55}Al₂O₄), and highly dispersed CuO, which contained less than 50% of the total copper. As per Example 1, wt % of the oxides was 24.06 CuO, 14.37 ZnO, and 61.58 Al₂O₃.

### Example 3

As in the first 2 examples, a sample of solution A was prepared. In this Example, “solution B” was prepared by combining 47.7 g (0.45 moles) of Na₂CO₃, and 18 g (0.45 moles) of NaOH, in 600 ml of distilled water, to produce a solution with a pH of 10.

Solution A was heated to 50° C., and solution B was added gradually, at a rate of 4 ml/min, with constant agitation. The resulting pH was 10.

A precipitate formed and was aged for 2 hours at 50° C., pH 8.5, during which the solution was filtered. Following washing, the precipitate was analyzed and found to contain about 99% of the Cu, Zn, and Al, but also contained a high amount of Na.

Following drying at room temperature for 12 hours, and then for 12 hours at 110° C., the dark brown precipitate was calcined at 500° C., for 2 hours.

The resulting product contained 40.5 wt % Cu, 13.3 wt % Zn, 13.8 wt % Al, and 0.47 wt % Na. The atomic ratio of the components Cu:Zn:Al was 3.1:1:2.5. The composition had a specific surface area of 62 m²/g, a pore volume of 0.15 cm³/g, and an average pore diameter of 8.7 nm. As with the preceding examples, the composition exhibited an X-ray amorphous oxide phase (Cu_{0.2}Zn_{0.8}Al₂O₄), and a highly dispersed crystal phase which contained most of the Cu. Again, as per the prior examples, the wt % of oxides was 42.46 CuO, 13.86 Zn, and 43.65 Al₂O₃.

### Example 4

The steps of Example 1 were followed, but the precipitate was filtered hot, and without aging. The calcined composition contained 40.2 wt % Cu, 9.7 wt % Zn, 17.2 wt % Al, and 0.22 wt % Na. The atomic ratio of Cu:Zn:Al was 4.2:1:4.3. The specific surface area was 75 m²/g, and the pore volume was 0.29 cm³/g. Average pore diameter was 12.5 nm. The phase composition was highly dispersed, crystalline phases of CuO, ZnO, and Al₂O₃. The amounts of oxides were 49.50 wt % CuO, 9.48 wt % ZnO, and 51.02 wt % Al₂O₃.

### Example 5

In this example, Example 2 was followed except 5.5×10⁻⁴ moles of cerium nitrate were added to solution A. After the precipitate was formed, it was aged for 6 hours at 55° C. Analysis of the calcined composition showed 20.9 wt % Cu, 17.1 wt % Zn, 23.9 wt % Al, and 0.5 wt % Ce. The atomic ratio of Cu:Zn:Ce:Al was 3.0:1:0.01:3.8. The composition had a specific area of 83 m²/g, a pore volume of 0.20 cm³/g, and an average pore diameter of 10.0 nm. It exhibited an X-ray amorphous oxide phase with a composition of Cu_{0.5}Zn_{0.5}Al₂O₄ and a highly dispersed crystalline phase of CuO, which contained less than 60% of the Cu, and also a cerium phase, with particles not exceeding 5 nm in diameter. While the amounts of oxides are not provided here or hereafter, the method set forth in Example 1, supra, can be followed to secure precise amounts thereof.

### Example 6

This example parallels Example 5, except the amount of cerium nitrate was increased to 9.5×10⁻³ moles. Precipitation formation and filtration were carried out at 65° C., for 6 hours.

The resulting calcined composition had the following composition: Cu: 20.2 wt %, Zn: 15.1 wt %, Al: 20.2 wt %, Ce: 8.5 wt %. Atomic ratios of Cu:Zn:Ce:Al were 1:35:1:0.25:3.2. The specific surface area was 125 m²/g, with a pore volume of 0.3 cm³/g. Average pore diameter was 8.0 nm. As with the other compositions, it exhibited an X-ray amorphous oxide phase and a formula of Cu_{0.5}Zn_{0.5}Al₂O₄. It also exhibited a cerium phase with particles not greater than 10 nm in diameter.

### Example 7

In this example, “solution A” contained 0.05 m Cu nitrate, 0.07 m Zn nitrate, and 0.13 m Al nitrate, in 500 ml of distilled water, at a pH of 2.6.

Solution B contained 53.0 g Na₂CO₃ (0.5 m), and 18 g NaOH (0.45 m), in 600 ml of water, at a pH of 12.2. The solutions were mixed and the resulting precipitate separated, as in Example 1. The calcined composition contained 10 wt % Cu, 20.0 wt % Zn, 21.3 wt % Al, and 0.65 wt % Na. The atomic ratio of Cu:Zn:Al was 0.5:1:1.5, with a specific surface area of 112 m²/g, a pore volume of 0.30 cm³/g, and average pore diameter of 10.8 nm. The composition exhibited formula Cu_{0.33}Zn_{0.67}Al₂O₄, and the composition also contained a highly dispersed crystalline ZnO phase.

### Example 8

In this example, solution A contained 0.5 m Cu nitrate, 0.07 m Zn nitrate, and 0.45 m Al nitrate, in 500 ml of distilled water, at pH 2.1.

Solution B was identical to solution B of Example 7, but the pH was 12.0.

Precipitation and separation of the precipitate took place over 6 hours, at 65° C., pH 6.5.

The resulting calcined product contained 10.0 wt % Cu, 12.1 wt % Zn, 33.8 wt % Al, and 0.05 wt % Na. The atomic ratio for Cu:Zn:Al was 0.84:1:6.7. The specific surface area was 100 m²/g, the pore volume 0.35 cm³/g, and the average pore diameter was 11.0 nm. The composition exhibited the same X-ray amorphous oxide phase formula Cu_{0.4}Zn_{0.6}Al₂O₄, and there was a γ-Al₂O₃ phase as well.

### Example 9

In this example, Solution A contained 0.05 m Cu nitrate, 0.02 m Zn nitrate, and 0.45 in Al nitrate, dissolved in 500 ml distilled water, and have a pH of 2.25.

Solution B contained 53.0 g (0.5 m) (NH₄)₂CO₃ dissolved in 600 ml of distilled water. The pH was 8.0.

Precipitation, and separation of the precipitate, took place over 4 hours, at 65° C., pH 6.5, to yield a composition containing 13.0 wt % Cu, 4.2 wt % Zn, and 36.5 wt % Al. The atomic ratio for Cu:Zn:Al was 3.1:1:21. The specific surface area was 150 m²/g, with a pore volume of 0.45 cm³/g, with an average pore volume of 9.5 nm. The observed formula of the composition was ZnAl₂O₄ and Al₂O₃ modified by Cu in the form of CuO.

### Example 10

In this example, solution A contained 0.25 m Cu, 0.07 m Zn, and 0.20 m Al in their nitrate form, dissolved in 500 ml of distilled water, at pH 2.3. Solution B contained 53.0 g Na₂CO₃ (0.5 in), and 12 g NaOH (0.3 m), in 600 ml distilled water, at pH 12.0.

Precipitation conditions were those of Example 1, supra, which did not permit total precipitation of Al. In fact, while the precipitation of Cu and Zn was 99% that of Al did not exceed 80%. The resulting composition contained 50 wt % Cu, 25.2 wt % Zn, 7.4 wt % Al, and 0.85 wt % Na. The atomic ratio of Cu:Zn:Al was 2.0:1.0:0.7. The specific surface area was 50 m²/g, the pore volume was 0.20 cm³/g, and the average pore diameter was 15.2 nm. The formula of the composition was Cu_{0.33}Zn_{0.67}Al2O4, with highly dispersed crystalline CuO and ZnO phases.

### Example 11

In this final synthesis example, solution A did not contain Al nitrate, but only 0.04 m Cu, 0.02 m Zn and 0.14 m Ce in nitrate form, dissolved in 500 ml of distilled water, at pH 4.2.

Solution B contained 15.0 g (NH₄)₂ CO₃ and 18.0 g NH₄HCO₃ in 600 ml distilled water, at a pH of 8.0.

Following calcination, the composition contained 6.5 wt % Cu, 3.85 wt % Zn, and 78 wt % Ce. The atomic ratio of components Cu:Zn:Ce was 1.7:1:9.5, and the specific surface area was 85 m²/g, with pore volume 0.23 cm³/g and average pore diameter of 10.9 nm. The observed composition was of formula Cu_{0.33}Zn_{0.67}Al₂O₄, with a highly dispersed crystalline CeO₂ phase.

### Example 12

The catalysts prepared in Examples 1-11, supra, were then tested for their ability to oxidatively desulfurize fuel oil containing sulfur-containing compounds. Fuels were prepared which contained thiophene, DBT (dibenzothiophene), and 4,6 DBT. The fuels were heated to gaseous state, and passed over the catalytic compounds. In the Tables which follow, the formulation of the catalyst (“Cu—Zn—Al,” “Cu—Zn—Al—Ce,” or “Cu—Zn—Ce”) is followed by “(1)” or “(2)”. This refers to the nature of “solution B” in Examples 1-11, with “(1)” referring to a Na containing solution and “(2)” to an ammonium containing solution, as per Examples 1 and 2. The final number indicates which example was used to produce the catalyst.

### Example 13

A diesel fuel, with the following properties: T₅₀: 264; T₉₅:351; density at 20° C., in kg/l: 0.841, sulfur, in wt %: 1.93, was oxidized with the catalyst of Example 1. Similarly, DBT was oxidized with each catalyst and 4,6 DMDBT was oxidized with the catalysts of Examples 1, 2, and 5:

TABLE 1
Oxidation of thiophene in octane solution

| | | S Content | | GHSV | WHSV | S Removal | HC Conversion |
|---|---|---|---|---|---|---|---|
| Catalyst | T ° C. | ppmw | O₂/S | h⁻¹ | h⁻¹ | W % | W % |
| Cu—Zn—Al (1)-1 | 329 | 1000 | 59 | 22500 | 28 | 90 | 1.2 |

TABLE 2
Oxidation of DBT in toluene solution

| | | S Content | | GHSV | WHSV | S removal | HC Conversion |
|---|---|---|---|---|---|---|---|
| Catalyst | T ° C. | ppmw | O₂/S | h⁻¹ | h⁻¹ | W % | W % |
| Cu—Zn—Al (1)-1 | 300 | 800 | 80 | 2600 | 6 | 87 | 2.1 |
| Cu—Zn—Al (2)-2 | 360 | 900 | 139 | 2900 | 6 | 53 | 3.5 |
| Cu—Zn—Al (1)-3 | 385 | 900 | 120 | 3700 | 8 | 69 | 3.9 |
| Cu—Zn—Al(1)-4 | 370 | 900 | 95 | 3200 | 8 | 31 | 2.9 |
| Cu—Zn—Al—Ce(2)-5 | 350 | 900 | 140 | 2900 | 6 | 55 | 3.1 |
| Cu—Zn—Al—Ce(2)-6 | 400 | 900 | 140 | 3100 | 6 | 26 | 3.0 |
| Cu—Zn—Al (1)-7 | 350 | 1100 | 100 | 1700 | 6 | 33 | 1.3 |
| Cu—Zn—Al (1)-8 | 340 | 1000 | 120 | 3900 | 6 | 48 | 3.7 |
| Cu—Zn—Al (1)-9 | 400 | 1500 | 40 | 27000 | 28 | 66 | 1.7 |
| Cu—Zn—Al (1)-10 | 340 | 1100 | 60 | 1500 | 6 | 24 | 3.3 |
| Cu—Zn—Ce(2)-11 | 310 | 800 | 70 | 2600 | 6 | 22 | 1.9 |
| Cu—Zn—Ce(2)-11 | 330 | 4100 | 30 | 4100 | 6 | 14 | 4.2 |

TABLE 3
Oxidation of 4,6-DMDBT in toluene solution

| | | S Content | | GHSV | WHSV | S Removal | HC Conversion |
|---|---|---|---|---|---|---|---|
| Catalyst | T ° C. | ppmw | O₂/S | h⁻¹ | h⁻¹ | % | % |
| Cu—Zn—Al (1)-1 | 312 | 900 | 140 | 2085 | 6 | 81 | 3.8 |
| Cu—Zn—Al (2)-2 | 350 | 1000 | 140 | 2100 | 6 | 78 | 3.5 |
| Cu—Zn—Al—Ce(2)-5 | 350 | 1000 | 140 | 2100 | 6 | 37 | 4.1 |

About 0.16 vol. % of H₂S, 0.118 vol. % of SO₂, and 5 vol. % of CO₂ were found at the reactor outlet.

In these tables, “GHSV” refers to the “gas volume rate” (in liters/hour), “WHSV” means “weight hourly space velocity: feed rate (Kg/hours) over the weight of the catalyst. “O₂/S” refers to the rate at which oxygen was introduced to the material being tested. “S” and “HC” refer to “sulfur” and “hydrocarbon,” respectively.

The foregoing examples describe features of the invention which include a catalytic composition useful, e.g., in oxidative removal of sulfur from gaseous, sulfur containing hydrocarbons, as well as processes for making the compositions, and their use.

The catalytic compositions comprise oxides of copper, zinc, and aluminum in defined weight percent ranges, and may also contain cerium oxide. The compositions exhibit an X-ray amorphous oxides phase with highly dispersed oxides of Zn, CU, and optionally Ce.

As noted, supra, the compositions contain defined amounts of the metallic oxides. The weight percentages permitted by the invention are 5 to less than 20 weight percent zinc oxide, from 10 to 50 weight percent copper oxide, and from 20 to 70 weight percent of aluminum oxide. When cerium oxide is present, its amount can range from 0.1 to 10 wt percent of the composition.

The aforementioned structure has the chemical formula CuₓZnₓ₋₁Al₂O₄, which is in accordance with the standard formula for spinets, i.e., “MAl₂O₄,” where “M” signifies a metal or combination of metals. Within the spinel, the ZnO and CuO are present as highly dispersed crystals. If cerium oxide is present, it is in particle form, with particles ranging in diameter from 5 nm to 10 nm. Preferably, X ranges from 0.1 to 0.6, more preferably, from 0.2 to 0.5.

The composition of the invention preferably are granular in nature, and may be formed into various embodiments such as a cylinder, a sphere, a trilobe, or a quatrolobe, preferably via processes discussed infra. The granules of the compositions preferably have diameters ranging from 1 mm to 4 mm. When the compositions contain CeO, as noted, supra, these particles will be smaller.

The compositions preferably have specific surface areas ranging from 10 m²/g to 100 m²/g, more preferably 50 m²/g to 100 m²/g, with pores ranging from 8 nm to 12 nm, more preferably, 8 nm to 10 nm. In preferred embodiments, the weight percentages are: 20-45 CuO, 10->20 ZnO, and 20-70 Al₂O₃, and most preferably 30-45 CuO, 12->20 ZnO, and 20-40 Al₂O₃.

The catalytic compositions of the invention are made by preparing an aqueous solution of the nitrates of Cu, Zn, and Al, and optionally Ce, and then combining this solution with an aqueous alkaline solution which contains NaOH, and/or one or more of (NH₄)₂CO₃, Na₂CO₃ and NH₄CO₃.

These solutions are combined at a temperature which may range from about 50° C. to about 65° C., and at a pH of from about 6.5 to about 11. The resulting hydroxides, carbonates, and/or hydroxycarbonates precipitate and are then filtered, washed, and dried, for at least ten hours, at a temperature of at least 100° C. After this, the resulting dried material is calcined, for about 2-4 hours, at a temperature of at least 450° C., to form the composition described herein.

The precipitate may be aged prior to the filtering and washing, as elaborated in the examples.

It is frequently desirable to form composites of the catalytic composition, and this is preferably done by adding a binder to the compositions prior to calcination. The binder may be, e.g., polyethylene oxide, polyvinyl alcohol, aluminum pseudoboehmite, silica gel, or mixtures thereof. The binder may be added in amounts ranging from about 1 wt % to about 20 wt % of the precipitate. The resulting mixture may be extruded through, e.g., a forming dye, and then dried, preferably at room temperature, for 24 hours, followed by drying at about 100° C. for 2-4 hours. The extrusion product is then heated slowly, e.g., by increasing temperatures by 2-5° C. every minute until a temperature of 500° C. is reached, followed by calcinations at 500° C. for 2-4 hours.

In practice, the compositions are used by combining them with a sulfur containing hydrocarbon, in gaseous form, together with an oxygen source, for a time sufficient for at least a portion of the sulfur to be oxidized to, e.g., SO₂. The oxygen source is preferably pure oxygen, but may be air, or any other oxygen source. Preferably, the materials recited supra are combined at conditions which include pressure of from 1-30 bars, temperature of from 200° C. to 600° C., with a weight hourly space velocity of from 1-20 h⁻¹, gas hourly space velocity of from 1,000-20,000 h⁻¹, with an oxygen carbon molar ratio of from 0.01 to 0.1, and a molar ratio of oxygen and sulfur of from 1 to 150. Preferably, the pressure ranges from 1-10 bars, most preferably 1-5 bars, the temperature is preferably from 250-500° C., and is most preferably 300-500° C. The gas hourly space velocity is preferably 5-15×10³ h⁻¹, most preferably 5-10×10³ while the preferred molar ration of O₂/C ranges from 0.02-0.1, and most preferably from 0.05-0.1, while that of O₂/S is from 10-100, and most preferably, from 20-50.

The feedstock, i.e., the sulfur containing hydrocarbon, will vary, but preferably is one with a boiling point above 36° C., and even more preferably, above 565° C.

In practice, the catalytic compositions are used in the form of, e.g., fixed beds, ebullated beds, moving beds, or fluidized beds.

Other features of the invention will be clear to the skilled artisan and need not be reiterated here.

The terms and expression which have been employed are used as terms of description and not of limitation, and there is no intention in the use of such terms and expression of excluding any equivalents of the features shown and described or portions thereof, it being recognized that various modifications are possible within the scope of the invention.

We claim:

1. A catalytic composition useful in oxidative desulfurization of gaseous, sulfur containing hydrocarbons, comprising copper oxide in an amount ranging from 10 weight percent (wt %) to 50 wt %, zinc oxide in an amount ranging from 5 wt % to less than 20 wt %, and aluminum oxide in an amount ranging from 20 wt % to 70 wt %, wherein said catalytic composition has an X-ray amorphous oxide phase, and a formula CuₓZn₁₋ₓAl₂O₄ wherein x ranges from 0 to 1, highly dispersed crystalline ZnO and CuO.

2. The catalytic composition of claim 1, further comprising CeO₂ in the form of particles ranging in diameter from 5 nm to 10 nm, in an amount ranging from 0.1 wt % to 10 wt % of said catalytic composition.

3. The catalytic composition of claim 1, in granular form.

4. The catalytic composition of claim 1, formed as a cylinder, a sphere, a trilobe, or a quatrolobe.

5. The catalytic composition of claim 1, wherein granules of said composition have a diameter of from 1 mm to 4 mm.

6. The catalytic composition of claim 1, having a specific surface area of from 10 m²/g to 100 m²/g.

7. The catalytic composition of claim 1, wherein pores of the granules of said composition have a diameter of from 8 nm to 12 nm.

8. The catalytic composition of claim 1, wherein pores of the granules of said composition have a volume of from about 0.1 cm³/g to about 0.5 cm³/g

9. The catalytic composition of claim 1, comprising from 20 wt % to 45 wt % CuO, from 10 wt % to less than 20 wt % ZnO, and from 20 wt % to 70 wt % of Al₂O₃.

10. The catalytic composition of claim 9, comprising from 30 wt % to 45 wt % CuO, from 12 wt % to less than 20 wt % ZnO, and from 20 wt % to 40 wt % Al₂O₃.

11. The catalytic composition of claim 6, having a specific surface area of from 50 m²/g to 100 m²/g.

12. The catalytic composition of claim 7, said pores having a diameter of from 8 nm to 10 nm.

13. The catalytic composition of claim 1, wherein X is from 0.1 to 0.6.

14. The catalytic composition of claim 13, wherein X is from 0.2 to 0.5.

15. A method for removing a portion of sulfur contained in a hydrocarbon, comprising contacting said sulfur containing hydrocarbon in gaseous form to the catalytic composition of claim 1, in the presence of an oxygen containing gas to remove a portion of sulfur therefrom.

16. A process for making the catalytic composition of claim 1, comprising:
(i) combining an aqueous solution containing each of copper nitrate, zinc nitrate, and aluminum nitrate with an alkaline solution containing NaOH and/or at least one of (NH₄)₂CO₃, Na₂CO₃ and NH₄HCO₃, at a temperature of from about 50° C. to about 65° C., and a pH of from about 6.5 to about 11, to form a precipitate containing at least one of (a) carbonates of Cu, Zn, and Al, (b) hydroxides of Cu, Zn, and Al, and (c) hydroxycarbonates of Cu, Zn, and Al;
(ii) aging said precipitate;
(iii) filtering and washing said precipitate;
(iv) drying said precipitate for at least 10 hours, at a temperature of at least 100° C.; and
(v) calcinating said precipitate for from about 2 to about 4 hours, at a temperature of at least about 450-500° C.
